(19) United States
(12) Patent Application Publication
(10) Pub. No.: US 2007/0095108 A1
(43) Pub. Date: May 3, 2007

(54) Methods and apparatus for reducing stress variations in glass sheets produced from a glass ribbon

(76) Inventors: Thomas Edward Kirby, Harrodsburg, KY (US); Shawn Rachelle Markham, Harrodsburg, KY (US)

Correspondence Address: CORNING INCORPORATED, SP-TI-3-1, CORNING, NY, 14831, US

(21) Appl. No.: 11/264,503

(22) Filed: Oct. 31, 2005

(51) Int. Cl. C03B 37/02; C03B 37/025; F27B 7/33

(52) U.S. Cl. 65/475; 65/435; 65/483; 65/533

(57) ABSTRACT

Apparatus and methods are provided for reducing the variability of stress levels in glass sheets (11) cut from a moving glass ribbon (13). The reductions in variability are achieved by constraining the edge regions (53,55) of the ribbon (13) from movement in a horizontal plane at at least one location below the location where a separating assembly (20) forms a separation line (47) in the ribbon (13). Sets of vertically arranged wheels (35) which engage the edge regions (53,55) of the ribbon (13) can be used to provide the horizontal constraint without compromising the central, quality area (51) of the glass ribbon (13).

### FIELD OF THE INVENTION

This invention relates to the manufacture of glass sheets such as the glass sheets used as substrates in display devices such as liquid crystal displays (LCDs). More particularly, the invention relates to methods for reducing the amount of distortion which glass substrates exhibit when cut into parts during, for example, the manufacture of such displays.

### BACKGROUND OF THE INVENTION

Display devices are used in a variety of applications. For example, thin film transistor liquid crystal displays (TFT-LCDs) are used in notebook computers, flat panel desktop monitors, LCD televisions, and Internet and communication devices, to name only a few.

Many display devices, such as TFT-LCD panels and organic light-emitting diode (OLED) panels, are made directly on flat glass sheets (glass substrates). To increase production rates and reduce costs, a typical panel manufacturing process simultaneously produces multiple panels on a single substrate or a sub-piece of a substrate. At various points in such processes, the substrate is divided into parts along cut lines.

Such cutting changes the stress distribution within the glass, specifically, the in-plane stress distribution seen when the glass is vacuumed flat. Even more particularly, the cutting relieves stresses at the cut line such that the cut edge is rendered traction free. Such stress relief in general results in changes in the vacuumed-flat shape of the glass sub-pieces, a phenomenon referred to by display manufacturers as “distortion.” Although the amount of shape change is typically quite small, in view of the pixel structures used in modern displays, the distortion resulting from cutting can be large enough to lead to substantial numbers of defective (rejected) displays. Accordingly, the distortion problem is of substantial concern to display manufacturers and specifications regarding allowable distortion as a result of cutting can be as low as 2 microns or less.

The present invention is directed to controlling distortion and, in particular, to methods for controlling distortion in sub-pieces cut from glass sheets produced by a vertical drawing process, such as, a downdraw process, an overflow downdraw process (also known as a fusion process), an updraw process, or the like.

### SUMMARY OF THE INVENTION

In accordance with a first aspect, the invention provides a method for producing sheets of glass (11) using a vertical drawing process, said method comprising:

forming a glass ribbon (13) using a forming assembly (41), said ribbon (13) having a central region (51) and two edge regions (53,55), each of which has a first side and a second side;

successively removing sheets of glass (11) from the ribbon (13) using a separating assembly (20) which forms a separation line (47) across the width of the ribbon (13), said separating assembly (20) being located below said forming assembly (41); and

guiding both the first and second sides of each of the ribbon's edge regions (53,55) into a vertical plane with an edge-guiding assembly (33), said edge-guiding assembly (33) being located below the location where the separating assembly (20) forms the separation line (47).

In certain preferred embodiments of the invention, step (c) reduces movement in a horizontal direction of at least a portion of the ribbon's central region (51), said portion being located between the forming assembly (41) and the separating assembly (20). In accordance with these embodiments, the temperature of the glass at said portion is preferably within the glass'glass transition temperature range. Although not wishing to be bound by any particular theory of operation, it is believed that in this way, variations in the stress levels of glass sheets (11) cut from the ribbon (13) are reduced at at least one location, e.g., along at least one edge of the glass sheet (11).

In accordance with a second aspect, the invention provides an assembly for guiding an edge region (53 or 55) of a glass ribbon (13) into a vertical plane comprising:

a body (49) which comprises a first vertical axis (59) and a second vertical axis (61);

a first set of vertically-spaced wheels (35) mounted on a support (63,67) which can be rotated about the first vertical axis (59) from a first position where the wheels cannot contact the edge region (53 or 55) of the glass ribbon (13) to a second position where the wheels (35) can engage and guide the edge region (53 or 55) of the glass ribbon (13), each of said wheels having a glass engaging surface (71); and

a second set of vertically-spaced wheels (35) mounted on a support (65,69) which can be rotated about the second vertical axis (61) from a first position where the wheels (35) cannot contact the edge region (53 or 55) of the glass ribbon (13) to a second position where the wheels (35) can engage and guide the edge region (53 or 55) of the glass ribbon (13), each of said wheels (35) having a glass engaging surface (71);

wherein the first and second vertical axes (59,61) are spaced apart so that when the first and second sets of wheels (35) are in their second positions, the spacing between the glass engaging surfaces (71) of the first set of wheels (35) and the glass engaging surfaces (71) of the second set of wheels (35) is sufficiently small (e.g., less than or equal to 20 millimeters) so as to maintain an edge region (53 or 55) of a glass ribbon (13) located between said glass engaging surfaces (71) in substantially a vertical plane.

For ease of presentation, the present invention is described and claimed in terms of the production of glass sheets. It is to be understood that throughout the specification and claims, the word “glass” is intended to cover both glass and glass-ceramic materials.

Also, the phrase “temperature of the glass” means the surface temperature of the glass ribbon at its centerline. Such temperatures can be measured by various techniques known in the art, such as with pyrometers and/or contact thermocouples.

The reference numbers used in the above summaries of the various aspects of the invention are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification. The drawings are not to scale. It is to be understood that the various features of the invention disclosed in this specification and in the drawings can be used in any and all combinations.

### BRIEF DESCRIPTION OF THE DRAWINGS

FIG. 1 is a schematic diagram illustrating a glass ribbon formed by a drawing process from which individual sheets of glass are cut. The locations of the edge regions of the ribbon relative to its centerline and central region are illustrated in this figure.

FIGS. 2A, 2B, and 2C illustrate the separation of a sheet of glass from a moving ribbon of glass.

FIG. 3 shows a guidance device constructed in accordance with the invention in its open position. FIG. 3A is a front view of the device and FIG. 3B is a top view.

FIG. 4 shows the guidance device of FIG. 3 in its closed position. Again, FIG. 4A is a front view and FIG. 4B is a top view.

FIG. 5 shows the guidance device of FIGS. 3 and 4 installed as part of a glass sheet forming line.

FIG. 6A illustrates a stationary edge-guiding assembly, and FIG. 6B illustrates an edge-guiding assembly that moves with a separating assembly.

FIG. 7 shows experimental data illustrating the reduction in the variability of stress levels that can be achieved by constraining horizontal movement of a glass ribbon below a separation line. In particular, FIG. 7A shows stress levels without constraint and FIG. 7B shows the stress levels achieved with constraint.

The reference numbers used in the figures correspond to the following:
glass sheet
moving glass ribbon
sheet removal sub-assembly
frame
sheet engaging members
separating assembly
scoring sub-assembly
anvil
scribe
transporter for scribe
transporter
connector assembly
edge-guiding assembly
wheels of edge-guiding device
schematic line illustrating a stationary edge-guiding assembly
schematic line illustrating a moving edge-guiding assembly
forming assembly which produces ribbon 13
pane transport system
pane grippers
separation line
body of edge-guiding device
central region of ribbon
edge region of ribbon
edge region of ribbon
centerline of ribbon
first vertical axis
second vertical axis
first support arm
second support arm
first support rail
second support rail
glass engaging surfaces of wheels 35
arrow indicating movement of at least a part of separating assembly 20
arrow indicating movement of glass sheet 13

### DETAILED DESCRIPTION OF THE INVENTION AND ITS PREFERRED EMBODIMENTS

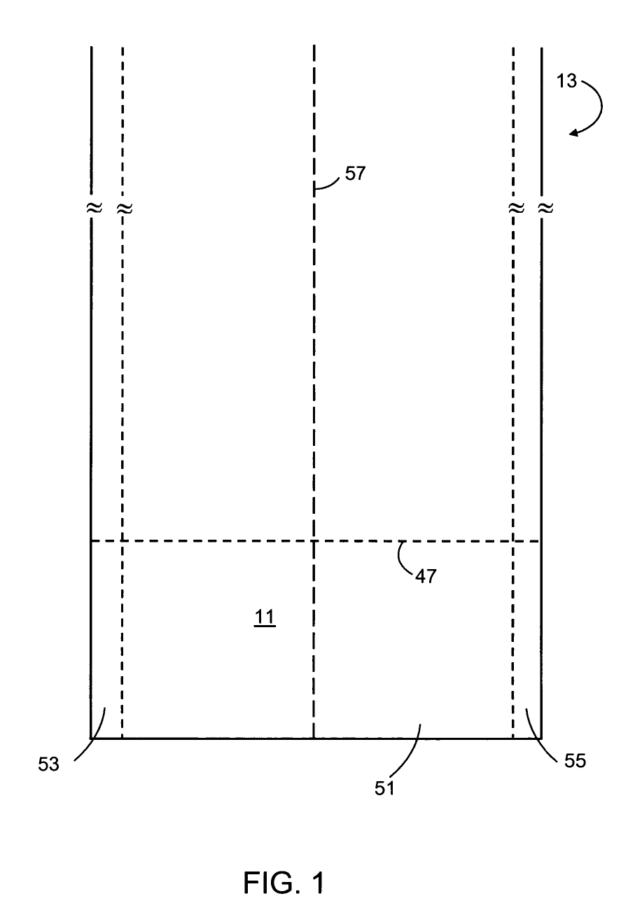

FIG. 1 shows a representative glass ribbon 13 which comprises a central region 51 (the quality portion of the ribbon) and two edge regions 53,55 (the non-quality or “bead” portions of the ribbon), which typically will contain a knurled pattern as a result of contact of these regions with one or more edge or pulling rollers. Also shown in this figure are the ribbon'centerline 57 and separation line 47 at which an individual glass sheet 11 is removed from the ribbon.

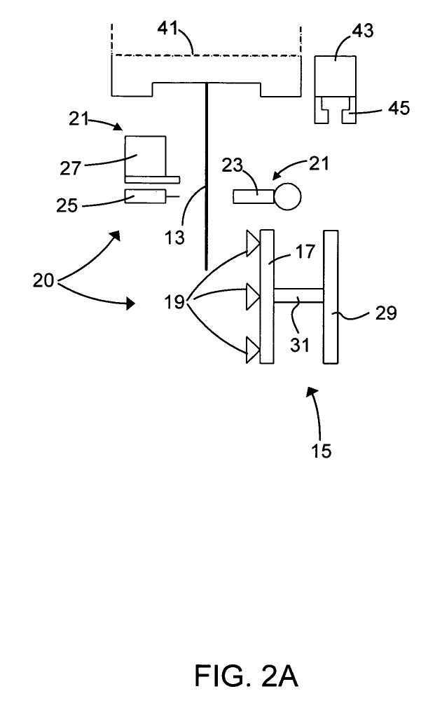

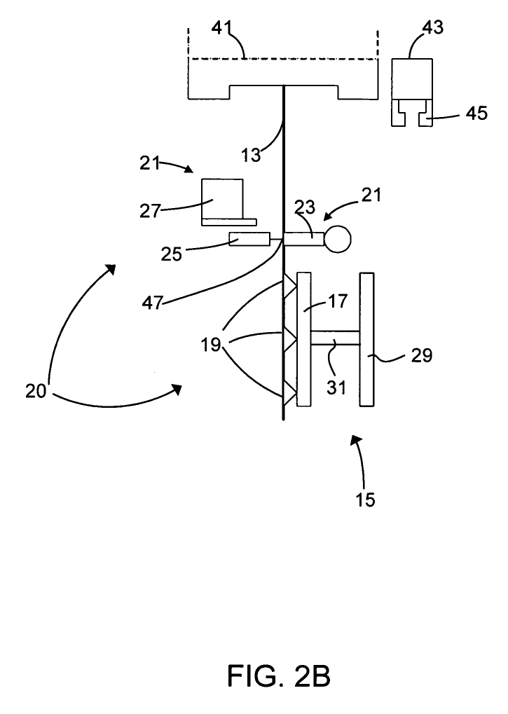

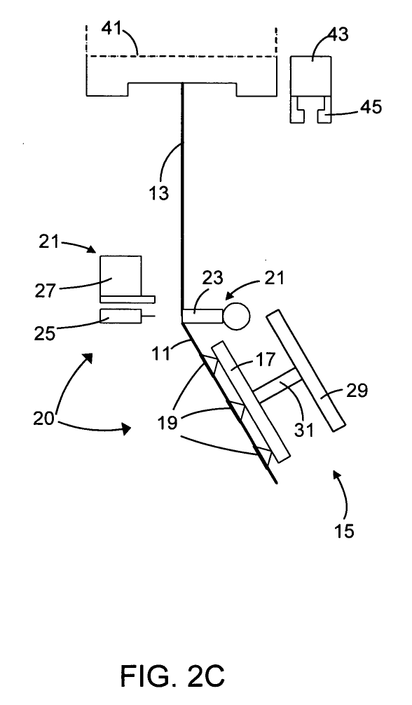

FIGS. 2A, 2B, and 2C show a suitable separating assembly 20 which can be used in accordance with the present invention to remove individual glass sheets 11 from ribbon 13. This assembly is of the type disclosed in commonly-assigned Andrewlavage, Jr., U.S. Pat. No. 6,516,025, the contents of which are incorporated herein by reference. Other equipment having different configurations and functionalities can, of course, be used in the practice of the invention if desired.

In each of FIGS. 2A, 2B, and 2C, the reference number 41 represents a forming assemble which produces glass ribbon 13, e.g., a forming assembly of the overflow downdraw type for producing LCD glass. As forming assemblies of this type are known in the art, details are omitted so as not to obscure the description of the present invention. Other types of glass forming apparatus (e.g., slot draw assemblies) can, of course, be used in conjunction with the invention. As with overflow systems, such apparatus is within the purview of the artisan of ordinary skill in glass manufacture.

Reference number 43 in FIGS. 2A, 2B, and 2C represents a sheet transport system which includes sheet grippers 45 for moving a separated sheet to further stages of the manufacturing process, e.g., to an edging station, an inspection station, etc. Again, because apparatus of this type is known in the art, details are omitted so as not to obscure the description of the invention. Apparatus other than that illustrated can, of course, be used in the practice of the invention.

FIG. 2A shows the overall system at the point where the leading edge of glass ribbon 13 has passed scoring sub-assembly 21 and is entering into the region of sheet removal sub-assembly 15. Scoring sub-assembly 21 can comprise anvil 23, scribe 25, and scribe transporter 27. As is conventional, the scoring assembly can be of the moving scribe/moving anvil type, although other types of scoring systems can be used if desired, e.g., laser based systems.

Sheet removal sub-assembly 15 can include frame 17 which carries sheet engaging members 19, e.g., four pane engaging members deployed at the four corners of a rectangle whose dimensions are smaller than the width and length of sheet 11. The pane engaging members 19 can, for example, be soft vacuum suction cups, although other apparatus for engaging a sheet of glass, e.g., clamps, can be used if desired. More or less than four pane engaging members can be used as desired.

Sheet removal sub-assembly 15 can include a transporter 29 which is connected to frame 17 through connector assembly 31. Transporter 29 can be an industrial robot and/or fixed automation for providing linear and rotational motion to the frame and connector assembly. Preferably, connector assembly 31 allows frame 17 and an attached glass sheet to undergo a controlled “fall” relative to the transporter once separation of the sheet from the ribbon has occurred at separation line 47.

FIG. 2B shows the formation of separation line 47 in glass ribbon 13 by scribe 25. As also shown in this figure, pane engaging members 19 have engaged the sheet. This engagement can take place either before or after the sheet has been scored. The engagement can be achieved by using a hard placement of the pane engaging members with respect to the sheet in combination with the use of sufficiently soft engaging members, e.g., soft vacuum suction cups, that will not cause undue motion of the sheet.

If the engagement is done after scoring, the engagement should not create a bending moment about the score line which will cause the pane to prematurely separate from the sheet. That is, the engagement needs to be accomplished while maintaining the plane of the glass. A reduced bending moment during engagement can be achieved by controlling the distance between the uppermost pane engaging member and the score line.

Whether sheet removal sub-assembly 15 is engaged with the pane before or after scoring, the sub-assembly needs to be attached to the pane before the bending moment which separates the pane from the ribbon is applied. As long as the plane of the glass is maintained, ribbon 13 can support substantial weight even when scored. The sheet only loses its strength when the separation line opens up and is driven through the sheet by the application of a bending moment which creates a tension/compression gradient in the glass.

FIG. 2C illustrates the application of the bending moment. As shown in this figure, the bending moment is preferably applied about the first side (unscored side) of the sheet using anvil 23 as a stop about which rotation takes place. In its preferred embodiments, connector assembly 31 immediately moves the trailing edge of the separated sheet away from the leading edge of the continually moving ribbon 13. In this way, edge damage can be minimized.

In practice, it has been found that as ribbon 13 leaves forming assembly 41 and moves towards separating assembly 20, there is a tendency for the glass to curl and not maintain a vertical travel. As the ribbon grows in length, its weight becomes sufficient to draw the glass back to a vertical plane. This movement, which can be of the order of 50 millimeters or more at the level of the bottom of the sheet removal sub-assembly, causes temporal changes in the shape of the ribbon along its length. In particular, the movement can cause changes in the shape of that portion of the ribbon that is passing through the glass'glass transition temperature range (GTTR).

In a fusion or other type of glass manufacturing process, as a glass ribbon cools, the glass making up the ribbon experiences intricate structural changes, not only in physical dimensions but also on a molecular level. The change from a supple approximately 50 millimeter thick liquid form at, for example, the root of an isopipe used in a fusion process to a stiff glass sheet of approximately a half millimeter of thickness is achieved by carefully controlling the cooling of the ribbon as it moves from the forming assembly to the separating assembly.

A critical portion of the cooling process takes place as the glass passes through its GTTR. In particular, the GTTR plays a critical role in distortion because of the behavior of the glass both within the GTTR and above and below the GTTR. At the higher temperatures which exist above the GTTR, glass behaves basically like a liquid: its response to an applied stress is a strain rate, and any elastic response is essentially undetectable. At the lower temperatures which exist below the GTTR, it behaves like a solid: its response to a stress is a finite strain, and any viscous response is essentially undetectable.

When glass cools from a high temperature and passes through the GTTR, it does not show an abrupt transition from liquid-like to solid-like behavior. Instead, the viscosity of the glass gradually increases, and goes through a visco-elastic regime where both the viscous response and the elastic response are noticeable, and eventually it behaves like a solid. As the glass is going through this process, it can take on a permanent shape which can affect the amount of stress in the glass and thus the amount of distortion exhibited when the glass is cut into sub-pieces in, for example, the manufacture of LCD displays.

In accordance with the invention, it has been found that the changes in the shape of the ribbon resulting from its increasing weight as it grows in length can result in “frozen in” changes in the shape of the ribbon in the GTTR and thus in variations in the stress levels of glass sheets cut from the ribbon. In particular, because this change in shape (or equivalently movement of portions of the ribbon out of the vertical plane) happens during the sheet forming cycle, it results in glass sheets whose tops and bottoms have different shapes and thus different stress values and different variations in those stress values. These deviations in stress values between the edges then impact the distortion values for the sheet when it is cut into sub-pieces.

As the length of the glass sheets employed in the manufacture of such products as LCD displays has increased (e.g., to lengths greater than 965 mm), the opportunity for out of plane movement of the glass ribbon below the forming assembly has increased. Thinner glass sheets also exhibit increased sheet movement, e.g., glass sheets having a thickness of less than 0.7 mm, such as sheet having a thickness of 0.5 mm, exhibit more out of plane movement. Larger shape changes, in turn, generally increase the level of stress and the level of stress variability of glass sheets cut from the ribbon. Thus, in order to effectively reduce the variability of the stress in the glass, the variability of the shape needs to be controlled.

In accordance with the invention, it has been found that the variability in the shape of a glass ribbon in the GTTR during a sheet separation cycle depends, at least in substantial part, upon movement of the glass ribbon at locations below the separation line, i.e., at locations substantially below the GTTR. This movement is transferred up the glass ribbon and becomes locked into the glass in the GTTR.

To reduce the amount of movement of the ribbon in the GTTR, the invention provides mechanical constraints on the movement of the ribbon below the separation line. The constrains help hold the ribbon in a vertical plane throughout the growth and separation of individual sheets. This constraining action reduces horizontal movement of the sheet before it is cut and removed from the glass ribbon, which, in turn, reduces horizontal movement of the ribbon at locations above the separation assembly, including horizontal movement of the ribbon in the GTTR. In this way, glass sheets having reduced stress variability levels are achieved. In particular, the stress from sample to sample is more consistent and the stress in the top edge is more similar to that in the bottom edge.

For example, a population of 50 sequential sheets produced with the horizontal motion of the ribbon constrained below the separation line will have a lower standard deviation in stress values in at least one location compared to a population of 50 sequential sheets produced under the same conditions but without such a constraint. The stress variability for example can be reduced from a standard deviation of 30 psi to 10 psi.

As known in the art, stress levels can be measured at one or more locations on a glass sheet using a birefringence technique. Such measurements will typically be made while the sheet is being vacuumed against a flat surface. Measurements can be made at locations distributed over the entire two-dimensional surface of the sheet or at just a limited number of locations, e.g., along one or more of the sheet's edges and/or at predetermined reference locations on the sheet, e.g., at locations near to the lines where the sheet will be divided into sub-pieces.

In order not to compromise glass quality, the constraints of the invention are applied along the edge regions of the ribbon. That is, the constraints are designed to stabilize the glass ribbon without contacting its quality area. Also, in its preferred embodiments, the apparatus used to apply the constraint to the ribbon has a configuration that can be readily integrated with an existing separating assembly with minimal or even no changes to the assembly.

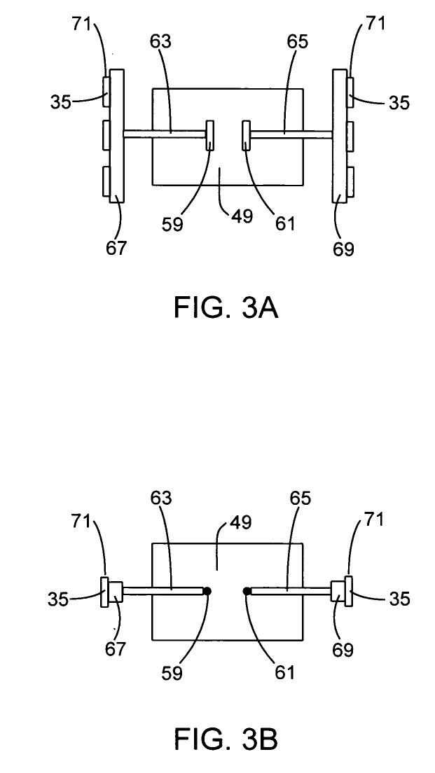

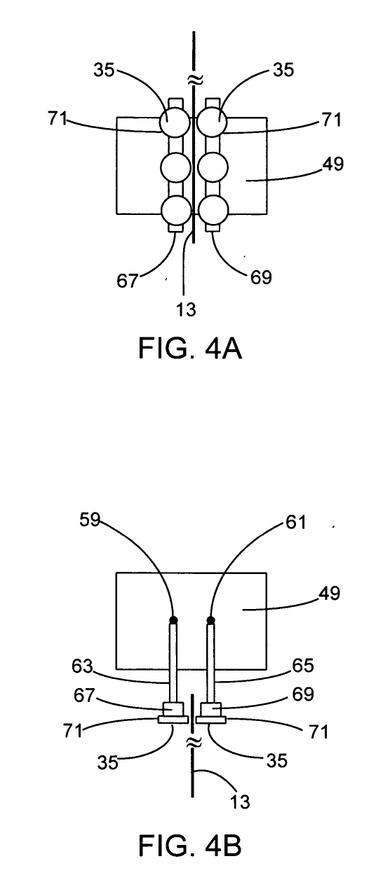

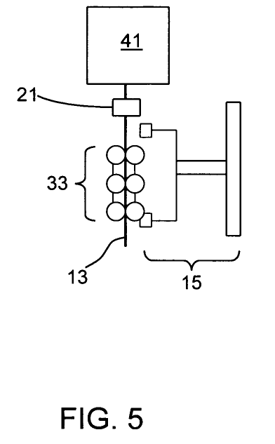

FIGS. 3 and 4 illustrate representative apparatus which can be employed in an edge-guiding assembly of the invention, and FIG. 5 illustrates the integration of this apparatus with a representative forming assembly 41, scoring sub-assembly 21, and sheet removal sub-assembly 15. As can be seen from these figures, this apparatus provides vertical planes of guidance wheels which can be placed on the front and back (first and second) surfaces of the ribbon on both of the ribbon's non-quality edge regions.

More particularly, FIGS. 3A and 4A are front views of the edge-guiding apparatus and FIGS. 3B and 4B are top views. FIG. 3 shows the apparatus in an open, non-guiding configuration, while FIG. 4 shows it in an edge-guiding configuration. Transformations between these configurations can be effectuated using conventional motive forces, such as electric motors or pneumatic drives (preferred). Although not shown, the apparatus preferably also has a configuration in which only one set of wheels 35 is brought out of engagement with glass ribbon 13, e.g., the set of wheels which would interfere with removal of individual glass sheets from the ribbon.

As shown in these figures, the apparatus can include a body 49 which has a first vertical axis 57 and a second vertical axis 61 (e.g., a pair of axles mounted to the body) to which arms 63 and 65 are rotatably connected. Arms 63 and 65 are, in turn, connected to rails 67 and 69 which carry a plurality of wheels 35 whose glass engaging surfaces 71 are aligned one above the other in a vertical plane. Although three wheels are shown in FIGS. 3-5, more or less wheels can be used in the practice of the invention as desired. The vertical length and number of wheels used will, in general, be a function of the length of the individual sheets being produced, with longer vertical lengths and greater numbers of wheels being used with longer sheets.

Because the edge-guiding assembly is located below the separating assembly, the temperature of the glass at this point of the process is relatively cool. This permits the use of a variety of materials in the construction of the assembly. For example, body 49, arms 63 and 65, rails 67 and 69, and wheels 35 can all be constructed of conventional metal materials, such as, aluminum. Other materials can, of course, be used if desired. Also, wheels 35 need not be driven to avoid excessive heat build-up, but can simply be allowed to acquire rotational motion through surface contact with the ribbon's edge regions. Driven wheels, however, can be used if desired. Rather than using wheels, the edge-guiding assembly of the invention can use other devices to control the horizontal motion of the ribbon below the separation line, such as low friction pads placed on the first and second sides of the ribbon's edge regions.

In practice, two guidance devices of the type shown in FIGS. 3 and 4 are used, one of which guides edge region 53 and the other of which guides edge region 55 (see FIG. 1). Each guidance device is adjusted in a horizontal plane to match the glass's vertical plane as it extends below the separation line. Preferably, the two devices are designed to be adjusted separately. In this way, the devices can be used with glass ribbons where the two edges of the ribbon are not in the same vertical plane.

Preferably, the glass engaging surfaces of the device can be moved independently in the horizontal plane so that the distance of those surfaces to the glass can be separately adjusted. Typically, the distance between the glass engaging surfaces and the glass ribbon is less than about 10 millimeters so that the total distance between the glass engaging surfaces which engage the first side of the glass ribbon and those which engage the second side is less than about 20 millimeters. As discussed above, the first side of the glass ribbon can be the unscored side of the glass while the second side can be the scored side, with the glass sheet being removed from the ribbon in the direction of the first side.

Smaller or larger distances between the glass engaging surfaces can, of course, be used in the practice of the invention depending on such variables as the flatness of the glass ribbon and the measured stress levels in sheets of glass cut from the ribbon. To provide sufficient flexibility, the guidance device preferably allows for spacings of between 0 mm and 20 mm between the glass engaging surfaces of the device and the surface of the ribbon.

In practice, the set of wheels on the first side of the ribbon disengage from the ribbon's surface so that an individual sheet can be removed from the ribbon by, for example, bending about a score line. The set of wheels on the second side can remain engaged to hold the ribbon in plane as the individual sheet is engaged and removed. Alternatively, the set of wheels on the second side can also be disengaged from the sheet during the sheet separation process.

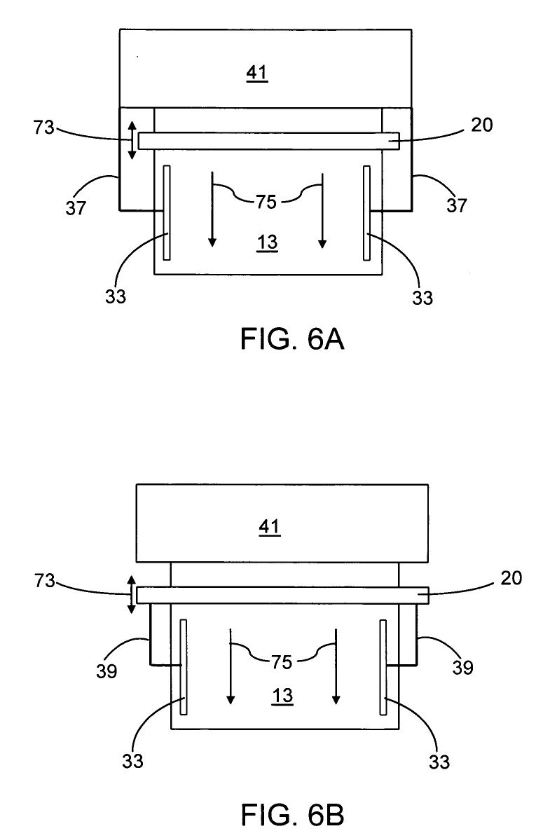

The guidance device can be mounted such that it travels vertically during the sheet removal cycle or remains stationary. FIGS. 6A and 6B illustrate the two possibilities. In these figures, arrow 73 indicates movement of at least a part of separating assembly 20, and arrow 75 indicates movement of glass sheet 13. Line 37 in FIG. 6A schematically represents the case where the edge guiding assembly is stationary with respect to forming apparatus 41, while line 39 in FIG. 6B schematically shows the edge guiding assembly moving with at least part of the separating assembly. For example, the edge guiding assembly can be affixed to a part of the scoring sub-assembly of the separating assembly and can move vertically with that part during the sheet creation and removal cycle.

Without intending to limit it in any manner, the present invention will be more fully described by the following example.

### EXAMPLE

A ribbon of glass produced by a fusion process and having a thickness of 0.5 mm was manually constrained from movement in a horizontal plane along its edges at a vertical location below the separation line. Stress measurements were made on consecutive samples produced with and without such constraint. In particular, stress measurements were made along the four edges of the sheets.

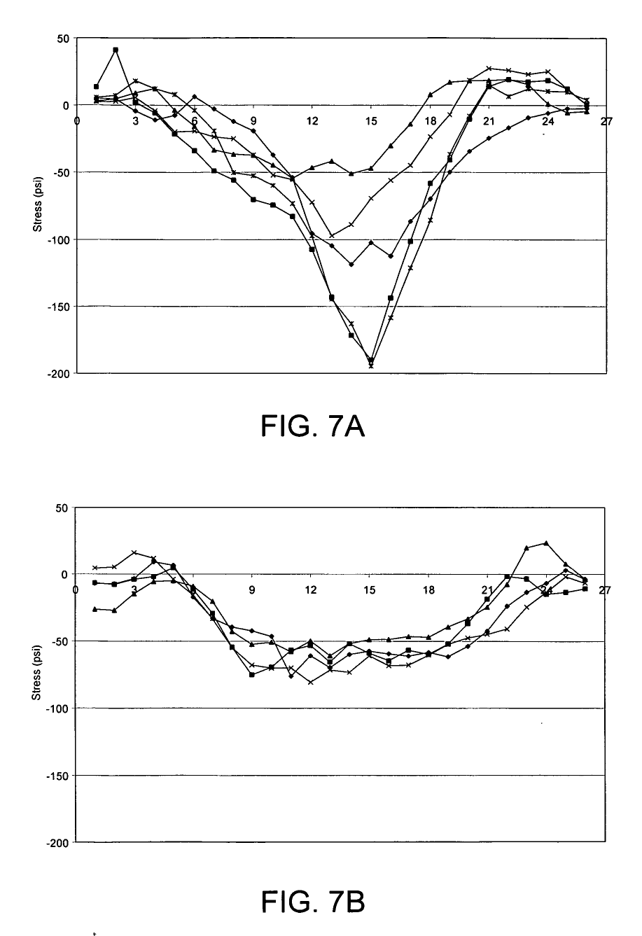

The highest variations in stress levels were observed for the edge corresponding to the side of the ribbon closest to the glass inlet to the isopipe used to produce the ribbon. Those stress levels are shown in FIG. 7A for the unconstrained case. FIG. 7B shows the results for the same edge when constrained as described above. The significant reductions in the variations in stress levels are evident. Reductions in stress variations were also seen for the other three edges, but since the levels of stress for the unconstrained condition were lower, the reductions achieved by constraining horizontal movement were less.

Although specific embodiments of the invention have been described and illustrated, it is to be understood that modifications can be made without departing from the invention's spirit and scope.

For example, although the above example used glass having a thickness of 0.5 mm, the invention can also be used with glasses having a variety of other thicknesses, e.g., glass having a thickness on the order of approximately 0.1 to 2.0 mm. More generally, the invention can be used in the manufacture of any type of glass used in displays or in other applications where thin glass sheets are beneficial. As representative examples, the glass may be Corning Incorporated's Code 1737 or Code Eagle 2000 glass, or glasses for display applications produced by other manufacturers.

A variety of other variations and modifications which do not depart from the scope and spirit of the invention will be evident to persons of ordinary skill in the art from the disclosure herein. The following claims are intended to cover the specific embodiments set forth herein as well as such variations, modifications, and equivalents.

What is claimed is:

1. A method for producing sheets of glass using a vertical drawing process, said method comprising:
(a) forming a glass ribbon using a forming assembly, said ribbon having a central region and two edge regions, each of which has a first side and a second side;
(b) successively removing sheets of glass from the ribbon using a separating assembly which forms a separation line across the width of the ribbon, said separating assembly being located below said forming assembly; and
(c) guiding both the first and second sides of each of the ribbon's edge regions into a vertical plane with an edge-guiding assembly, said edge-guiding assembly being located below the location where the separating assembly forms the separation line.

2. The method of claim 1 wherein step (c) reduces movement in a horizontal direction of at least a portion of the ribbon's central region, said portion being located between the forming assembly and the separating assembly.

3. The method of claim 2 wherein the temperature of the glass at said portion is within the glass'glass transition temperature range.

4. The method of claim 3 wherein a population of 50 sequential sheets produced using step (c) has a lower standard deviation of stress in at least one location compared to a population of 50 sequential sheets produced under the same conditions but without step (c).

5. The method of claim 1 wherein the separating assembly comprises a scoring sub-assembly which produces the separation line and a sheet removal sub-assembly which engages the ribbon and separates a sheet from the ribbon at the separation line.

6. The method of claim 5 wherein prior to the separation of the sheet from the ribbon by the sheet removal sub-assembly, the edge-guiding assembly ceases guiding the first sides of the edge regions.

7. The method of claim 1 wherein the separating assembly comprises at least one sub-assembly which, for a portion of the time period between the separation of successive sheets from the ribbon, moves vertically at the same rate as the ribbon.

8. The method of claim 7 wherein for a portion of the time period between the separation of successive sheets from the ribbon, the edge-guiding assembly moves vertically at the same rate as the ribbon.

9. The method of claim 8 wherein the edge-guiding assembly is affixed to at least one vertically-moving sub-assembly of the separating assembly.

10. The method of claim 7 wherein the edge-guiding assembly does not move vertically during the time period between the separation of successive sheets from the ribbon.

11. The method of claim 1 wherein the edge-guiding assembly comprises first, second, third, and fourth sets of wheels, the first of which guides the first side of one of the edge regions, the second of which guides the second side of said one of the edge regions, the third of which guides the first side of the other edge region, and the fourth of which guides the second side of said other edge region.

12. The method of claim 11 wherein the sets of wheels are brought into a guiding relationships with the ribbon through rotation about vertical axes.

13. An assembly for guiding an edge region of a glass ribbon into a vertical plane comprising:
(a) a body which comprises a first vertical axis and a second vertical axis;
(b) a first set of vertically-spaced wheels mounted on a support which can be rotated about the first vertical axis from a first position where the wheels cannot contact the edge region of the glass ribbon to a second position where the wheels can engage and guide the edge region of the glass ribbon, each of said wheels having a glass engaging surface; and
(c) a second set of vertically-spaced wheels mounted on a support which can be rotated about the second vertical axis from a first position where the wheels cannot contact the edge region of the glass ribbon to a second position where the wheels can engage and guide the edge region of the glass ribbon, each of said wheels having a glass engaging surface;
wherein the first and second vertical axes are spaced apart so that when the first and second sets of wheels are in their second positions, the spacing between the glass engaging surfaces of the first set of wheels and the glass engaging surfaces of the second set of wheels is sufficiently small so as to maintain an edge region of a glass ribbon located between said glass engaging surfaces in substantially a vertical plane.

14. The assembly of claim 13 wherein the spacing between the glass engaging surfaces of the first set of wheels and the glass engaging surfaces of the second set of wheels when those wheels are in their second positions is less than or equal to 20 millimeters.
